(19) United States
(12) Patent Application Publication
(10) Pub. No.: US 2006/0239719 A1
(43) Pub. Date: Oct. 26, 2006

(54) Developing cartridge and electrophotographic image forming apparatus having the same

(75) Inventors: Jean-man Sur, Suwon-si (KR); Ki-ju Pak, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/366,738

(22) Filed: Mar. 3, 2006

(30) Foreign Application Priority Data
Apr. 22, 2005 (KR) 2005-33541

(51) Int. Cl. G03G 15/08

(52) U.S. Cl. 399/258

(57) ABSTRACT

An electrophotographic color image forming apparatus is provided including a plurality of toner cartridges and a plurality of developing cartridges. Each of the developing cartridges includes an accommodating unit in which a developing roller is arranged and a toner supply unit which extends from a surface of the accommodating unit to connect the toner cartridges to the accommodating unit.

### CROSS-REFERENCE TO RELATED APPLICATIONS

This application claims the benefit under 35 U.S.C. 119(a) of Korean Patent Application No. 10-2005-0033541, filed on Apr. 22, 2005, the entire disclosure of which is hereby incorporated by reference.

### BACKGROUND OF THE INVENTION

1. Field of the Invention

The present invention relates to a developing cartridge for an image forming apparatus. More particularly, the present invention relates to an electrophotographic color image forming apparatus which prints a color image by sequentially operating a plurality of developing cartridges.

2. Description of the Related Art

Generally, a color image forming apparatus using an electrophotographic method creates a color image by forming an electrostatic latent image on a photosensitive medium charged with a uniform electric potential by emitting a beam onto the photosensitive medium, developing the electrostatic image with a toner of a predetermined color, and transferring and fixing the developed image onto print paper. Colors of toners used in the color image forming apparatus are usually yellow (Y), magenta (M), cyan (C), and black (K). Therefore, in order for the four color toners to the electrostatic latent image, four developing cartridges are required. Thus, typically, the size of the electrophotographic color image forming apparatus is larger than that of a monochromatic image forming apparatus.

In addition, a developing cartridge must be replaced when the toner accommodated inside the developing cartridge is finished. The amount of toner accommodated inside the developing cartridge is generally enough to print images on thousands of sheets of paper. However, components of the developing cartridge such as a developing roller may have more extensive lifecycles than the toner.

Nevertheless, it is necessary to replace the developing cartridge after the toner is consumed. Consequently, the developing roller is also replaced prematurely, which increases costs.

Accordingly, there is a need for an improved developing cartridge which is separate from a toner cartridge for reducing costs and to allow the size of an electrophotographic color image forming apparatus to be minimized.

### SUMMARY OF THE INVENTION

An aspect of the present invention is to address at least the above problems and/or disadvantages and to provide at least the advantages described below. Accordingly, an aspect of the present invention is to provide a compact developing cartridge which is separate from a toner cartridge that can reduce costs of consumables and allow the size of an electrophotographic color image forming apparatus to be minimized.

According to an aspect of the present invention, there is provided a developing cartridge which develops an electrostatic latent image on a photosensitive medium by receiving toner from a toner cartridge. The developing cartridge comprises an accommodating unit including a developing roller and a toner supply unit which extends from a surface of the accommodating unit to connect the toner cartridge to the accommodating unit.

According to another aspect of the present invention, there is provided an electrophotographic color image forming apparatus, including a photosensitive medium, a plurality of toner cartridges, and a plurality of developing cartridges which develop an electrostatic latent image on the photosensitive medium by receiving toner from the respective toner cartridges. Each of the developing cartridges comprises an accommodating unit including a developing roller and a toner supply unit which extends from a surface of the accommodating unit to connect the toner cartridge to the accommodating unit.

The toner supply units of the developing cartridges may be disposed at different locations along the length direction of the accommodating units.

A portion of each of the toner cartridges may be exposed to the outside of the electrophotographic color image forming apparatus.

The widths of the toner supply units may be narrower than the widths of the accommodating units.

Each of the toner supply units may include a transport element which transports the toner from the toner cartridge to the accommodating unit. The transport elements may be helical coils.

According to another aspect of the present invention, there is provided an electrophotographic color image forming apparatus, including a photosensitive medium, a plurality of toner cartridges, and a plurality of developing cartridges which develop an electrostatic latent image on the photosensitive medium by receiving toner from the respective toner cartridges. Each of the developing cartridges comprises an accommodating unit including a developing roller and a toner supply hole formed in a cover of the accommodating unit via which the toner is supplied.

The toner supply hole of the developing cartridges may be disposed at different locations along the length direction of the accommodating units.

Other objects, advantages; and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a schematic structural diagram of an electrophotographic color image forming apparatus including a photosensitive drum according to an embodiment of the present invention;

FIG. 2 is a schematic structural diagram of an electrophotographic color image forming apparatus including a photosensitive belt according to an embodiment of the present invention;

FIG. 3 is an exploded perspective view of a developing cartridge and a toner cartridge illustrated in FIG. 1;

FIG. 4 is a cross-sectional view of the developing cartridge and the toner cartridge illustrated in FIG. 3;

FIG. 5 is a perspective view illustrating an arrangement of toner supplying units of the developing cartridges in FIG. 1;

FIG. 6 is an exploded perspective-view of a developing cartridge and a toner cartridge according to another embodiment of the present invention;

FIG. 7 is a cross-sectional view of the developing cartridge and the toner cartridge illustrated in FIG. 6;

FIG. 8 is a perspective view of an arrangement of toner supplying units of the developing cartridges in FIG. 6; and

FIG. 9 is a perspective view illustrating changing of the toner cartridge in FIG. 1.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

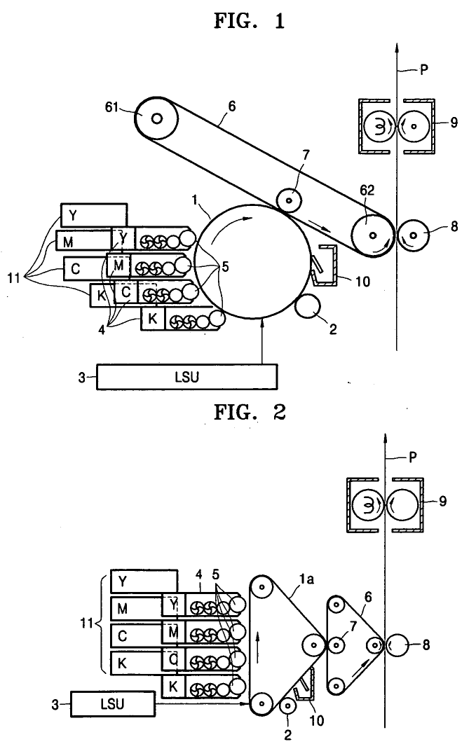

FIG. 1 is a schematic structural diagram of an electrophotographic color image forming apparatus including a photosensitive drum 1 according to an exemplary embodiment of the present invention. Referring to FIG. 1, the electrophotographic color image forming apparatus includes the photosensitive drum 1, a charging roller 2, an exposure unit 3, developing cartridges 4, an intermediate transfer belt 6, a first transfer roller 7, a second transfer roller 8, and a fixing unit 9.

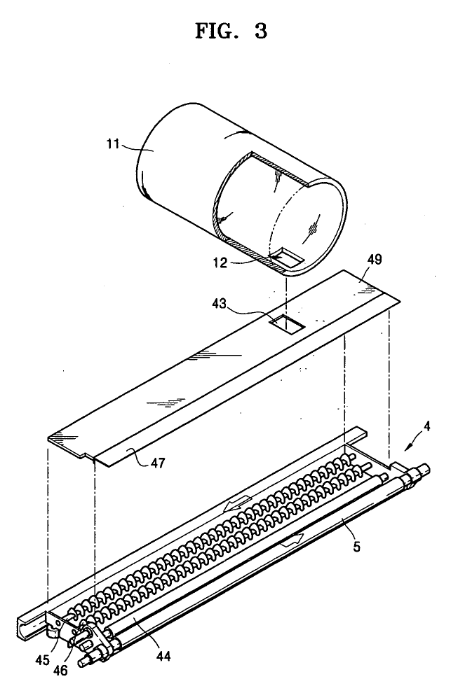

An optical conductive layer is formed on an outer circumference of the photosensitive drum 1, which is a cylindrical drum preferably made of metal. A photosensitive belt 1 a as illustrated in FIG. 2 can also be used instead of the photosensitive drum 1 as the photosensitive medium. The charging roller 2 is an example of a charging unit which charges the photosensitive drum 1 with a uniform potential. The charging roller 2 charges the outer circumference of the photosensitive drum 1 with a uniform potential. The charging roller 2 supplies electric charges to the outer circumference of the photosensitive drum 1 while rotating in and out of contact with the outer circumference of the photosensitive drum 1. A corona discharger (not shown) may be used instead of the charging roller 2. The exposure unit 3 emits light corresponding to image information to the photosensitive drum 1 charged with a uniform potential to form an electrostatic latent image. The exposure unit 3 can be a laser scanning unit (LSU) which typically uses a laser diode as a light source.

The electrophotographic image forming apparatus of the present embodiment uses cyan (C), magenta (M), yellow (Y), and black (K) toners to print a color image. Hereinafter, when there is a need to differentiate components according to their colors, C, M, Y and K will be listed next to the reference numbers of each component so that they are distinguishable.

The electrophotographic image forming apparatus of the present embodiment includes four toner cartridges 11Y, 11M, 11C, and 11K, respectively, accommodating yellow, magenta, cyan, and black color toners, and four developing cartridges 4Y, 4M, 4C, and 4K which respectively receive the toner cartridges 11Y, 11M, 11C, and 11K to develop the electrostatic latent image formed on the photosensitive drum 1. Each of the developing cartridges 4 includes a developing roller 5. The developing cartridge 4 is disposed so that the developing roller 5 is separated from the photosensitive drum 1 by a predetermined distance which forms a developing gap. The developing gap may be approximately tens to hundreds of microns. In a multi-pass type color image forming apparatus, the plurality of developing cartridges 4 are sequentially operated. One of the developing cartridges, for example, the developing cartridge 4Y is selected and a developing bias is supplied to the developing roller 5Y of the selected developing cartridge 4Y. The developing bias is not supplied to the developing rollers 5 of the rest of the developing cartridges, for example, the developing cartridges 4M, 4C, and 4K. Additionally, the developing roller 5 of the selected developing cartridge 4Y rotates; however, the developing rollers 5 of the rest of the developing cartridges 4M, 4C, and 4K do not rotate.

The intermediate transfer belt 6 is supported by support rollers 61 and 62 which move at the same speed as the speed of the outer circumference of the photosensitive drum 1. The length of the intermediate transfer belt 6 is equal to or greater than the length of a maximum sized sheet of printing paper P used in the electrophotographic color image forming apparatus. The first transfer roller 7 faces the photosensitive drum 1, and a first transfer bias is supplied to the first transfer roller 7 so that a toner image developed on the photosensitive drum 1 is transferred onto the intermediate transfer belt 6. The second transfer roller 8 is disposed to face the intermediate transfer belt 6. The second transfer roller 8 separates from the intermediate transfer belt 6 while the toner image transfers from the photosensitive drum 1 onto the intermediate transfer belt 6. When the toner image is completely transferred onto the intermediate transfer belt 6, the second transfer roller 8 contacts the intermediate transfer belt 6 with a predetermined pressure. A second transfer bias for transferring the toner image onto the print paper P is supplied to the second transfer roller 8. A cleaning element 10 removes toner remaining on the photosensitive drum after the toner image is transferred.

A process of forming a color image using the above-described electrophotographic image forming apparatus will now be described. The exposure unit 3 emits light corresponding to, for example, yellow color image information onto the photosensitive drum 1 charged with a uniform potential by the charging roller 2 such that an electrostatic latent image corresponding to a yellow color image is formed on the photosensitive drum 1. A developing bias is supplied to the developing roller 5 of the yellow color developing unit 4Y. Then, the yellow toner adheres to the electrostatic latent image, thereby forming a yellow color toner image on the photosensitive drum 1. The yellow color toner image is transferred onto the intermediate transfer belt 6 due to the first transfer bias supplied to the first transfer roller 7. After transferring the yellow color toner image for a printing paper P is completed, the exposure unit 3 emits light corresponding to, for example, magenta color image information onto the photosensitive drum 1 recharged with a uniform potential by the charging roller 2, thereby forming an electrostatic latent image corresponding to the magenta color image. The magenta developing unit 4M develops the electrostatic latent image by supplying a magenta toner thereto. The magenta color toner image formed on the photosensitive drum 1 is transferred to the intermediate transfer belt 6 to overlap the yellow toner image. If the same process is performed also for the cyan and black colors, a color toner image is produced by sequentially overlapping the yellow, magenta, cyan, and black color toner images. The color toner image is transferred onto the print paper P passing between the intermediate transfer belt 6 and the second transfer roller 8 due to the second transfer bias. The fixing unit 9 fixes the color toner image onto the print paper P by applying heat and pressure. By the process described above, a multi-pass type color image forming apparatus including the single photosensitive drum (photosensitive medium) 1, the exposure unit 3, and the four developing cartridges 4 can be configured.

As described above, the characteristics of the electrophotographic color image forming apparatus according to the present embodiment is that the toner cartridges 11 in which the toners are accommodated are separate from the developing cartridges 4.

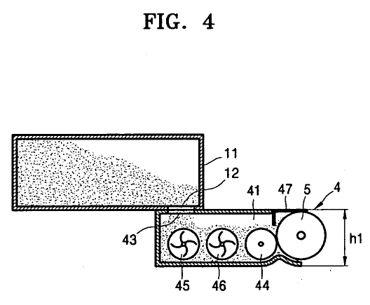

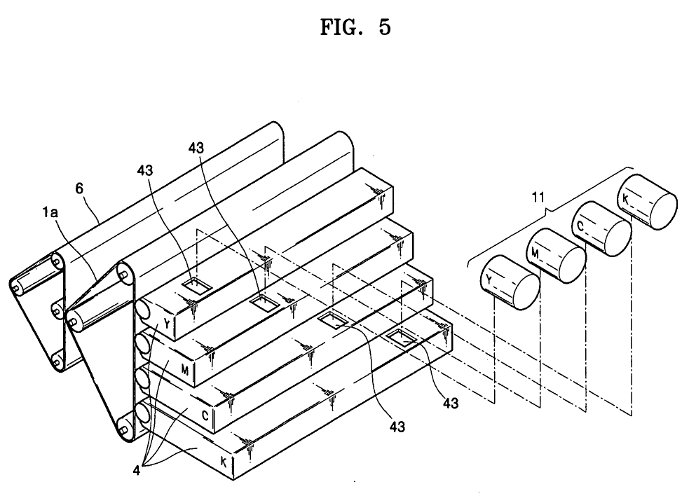

Referring to FIGS. 3 and 4, the developing cartridge 4 includes an accommodating unit 41 including the developing roller 5, a cover 49 covering the accommodating unit 41, and a toner supplying hole 43 formed on the cover 49. First and second augers 45 and 46 and a supply roller 44 are installed in the accommodating unit 41. The first and second augers 45 and 46 supply the toner supplied through the toner supply unit 43 towards the developing roller 5. The first and second augers 45 and 46 may supply the toner in opposite directions to each other. Therefore, the toner is supplied in the directions indicated by the arrows in FIG. 3. The supply roller 44 charges and adheres the toner (non-magnetic toner) to the developing roller 5 while rotating in contact with the developing roller 5. A regulating blade 47 regulates the thickness of the toner adhered to the developing roller 5. Although not illustrated in the drawing, the toner cartridge 11 includes a shutter which blocks an outflow hole 12 when the toner cartridge 11 separates from the developing cartridge 4, and opens the outflow hole 12 when the toner cartridge 11 is installed in the developing cartridge 4. When the toner cartridge 11 is coupled to the developing cartridge 4, the outflow hole 12 and the toner supply hole 43 are aligned, and thus the toner is supplied from the toner cartridge 11 to the developing cartridge 4. By having such a structure, only the toner cartridge 11 needs replacement when all of the toner is consumed. The developing cartridge 4 is replaced only at the end of its lifecycle. Therefore, the cost for replacing consumables is reduced, thereby reducing operating costs.

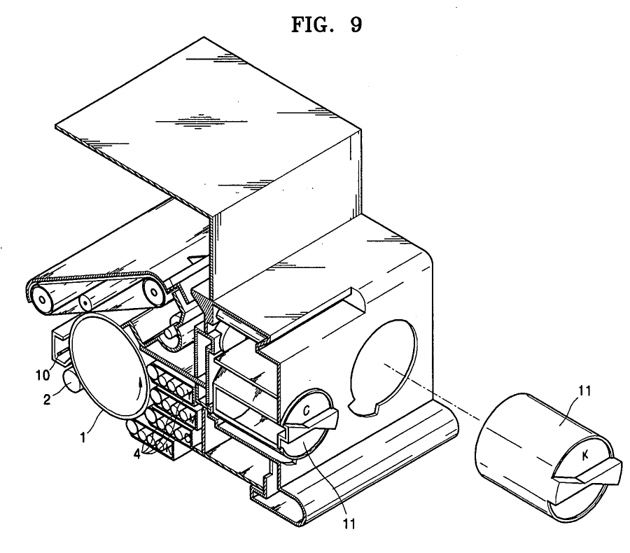

The four developing cartridges 4Y, 4M, 4C, and 4K are disposed in line along the direction the photosensitive medium 1 and the photosensitive belt 1a travel as illustrated in FIGS. 1 and 2. The toner supply hole 43 of the four developing cartridges 4Y, 4M, 4C, and 4K are displaced from one another along the length direction of the accommodating unit 41, as illustrated in FIG. 5. According to this structure, the four toner cartridges 11Y, 11M, 11C, and 11K can be disposed so as not to interfere with one another. Also, because at least portions of three toner cartridges 11M, 11C, and 11K overlap three developing cartridges 4Y, 4M and 4C, the height of the electrophotographic color image forming apparatus caused by the four toner cartridges 11Y, 11M, 11C, and 11K can be minimized. As a result, a electrophotographic color image forming apparatus can be minimized in size. In addition, the toner cartridges 11Y, 11M, 11C, and 11K can be arranged so that interference among themselves or with the developing cartridges 4Y, 4M, 4C, and 4K can be reduced when removing one of the toner cartridges 11Y, 11M, 11C, and 11K. Therefore, when a portion of the toner cartridge 11 is configured to be exposed outside the electrophotographic color image forming apparatus as illustrated in FIG. 9, the toner cartridge 11 can be removed without opening the electrophotographic color image forming apparatus. Consequently, user convenience can be improved.

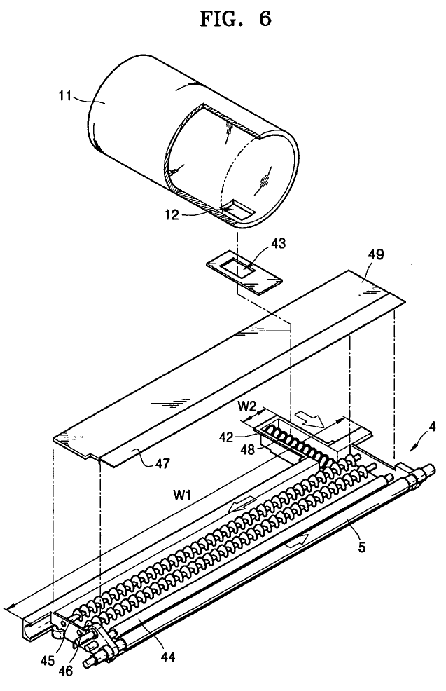

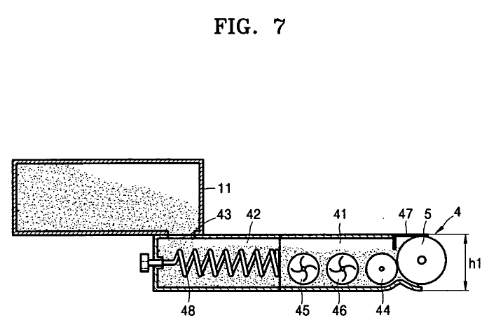

FIGS. 6 and 7 are an exploded perspective view and a cross-sectional view of a developing cartridge 4 and a toner cartridge 11 according to another exemplary embodiment of the present invention.

Referring to FIGS. 6 and 7, the developing cartridge 4 includes an accommodating unit 41 in which the developing roller 5 is installed, and a toner supplying unit 42. A toner supply hole 43 which receives the toner output from the toner cartridge 11 is formed in the cover 49. Also, a regulating blade 4 may be installed on cover 49. Although not illustrated in the drawing, the toner cartridge 11 includes a shutter which blocks an outflow hole 12 when the toner cartridge 11 separates from the developing cartridge 4, and opens the outflow hole 12 when toner cartridge 11 is installed in the developing cartridge 4. Accordingly, only the toner cartridge 11 needs replacement when all of the toner is consumed. The developing cartridge 4 is exchanged at the end of its lifecycle. Therefore, the cost for replacing consumables is reduced, thereby decreasing operating costs.

The toner supplying unit 42 extends from surface such as the rear of the accommodating unit 41. With this structure, a relatively slim developing cartridge 4 is formed. For example, when the diameter of the developing roller 5 is about 10 mm, the height h1 of the developing cartridge 4 can be more or less than about 15 mm.

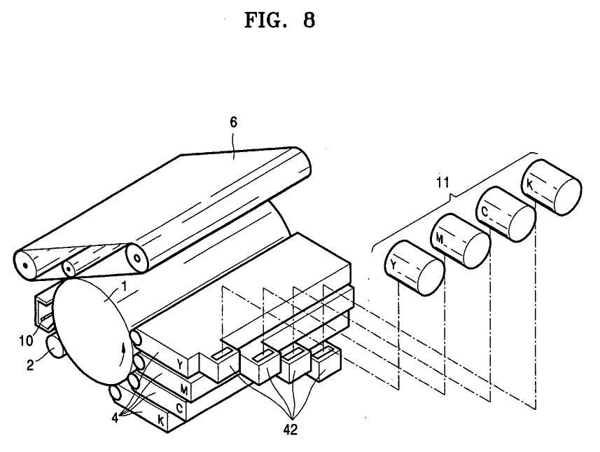

The width w2 of the toner supplying unit 42 may be narrower than the width w1 of the accommodating unit 41. In order for the toner to naturally flow from the toner cartridge 11 into the toner supplying unit 42 due to gravity, the supply hole 43 is preferably placed on top of the toner supply unit 42. As illustrated in FIGS. 1 and 2, the four developing cartridges 4Y, 4M, 4C, and 4K are disposed along the traveling direction of the photosensitive drum 1 and photosensitive belt 1a. The toner supplying units 42 of the respective developing cartridges 4Y, 4M, 4C, and 4K are displaced from one another along the length direction of the accommodating unit 41 as illustrated in FIG. 8. According to this structure, the four toner cartridges 11Y, 11M, 11C, and 11K can be disposed so as not to interference with one another. In addition, because at least portions of the bottom three toner cartridges 11M, 11C, and 11K overlap the top three developing cartridges 4Y, 4M and 4C, the ;height of the electrophotographic color image forming apparatus caused by the four tonet cartridges 11Y, 11M, 11C, and 11K can be minimized. Thus, the electrophotographic color image forming apparatus can be minimized. Furthermore, when removing one of the toner cartridges 11Y, 11M, 11C, and 11K, an arrangement can be made so that interference among the developing cartridges 4Y, 4M, 4C, and 4K or the toner cartridges 11Y, 11M, 11C, and 11K does not occur. Therefore, when a portion of the toner cartridge 11 is configured to be exposed outside the electrophotographic color image forming apparatus as illustrated in FIG. 6, the toner cartridge can be removed without opening the electrophotographic color image forming apparatus. As a result, user convenience can be improved.

A transporting element which transports the toner supplied from the toner cartridge 11 to the accommodating unit 41 may be further included in the toner supply unit 42. A helical coil 48 is used as the transporting element as illustrated in FIGS. 3 and 4. Various devices such as an auger or a transport belt (not shown) can be used as the transporting element, but the helical coil 48 has the following advantages. The helical coil 48 is inexpensive compared to the auger or the transport belt, and the amount transported by the helical coil 48 can be easily controlled by controlling the number of windings (number of turns) of the helical coil 48 or the cross-sectional area of the helical coil 48. In addition, the amount of toner supplied is automatically controlled according to the amount of toner used in the developing process. In other words, the amount of toner used in the accommodating unit 41 is different depending on the density of the image to be developed. For example, when developing a low-density color image, only a small amount of toner needs to be supplied to the accommodating unit 41. However, in the case of using the auger or the transport belt, the same amount of toner is always supplied to the accommodating unit 41 because the transport pressure of the auger or the transport belt is relatively high. Then, the pressure on the toner inside the accommodating unit 41 increases, and leakage: of the toner to the outside of the developing cartridge 4 may occur. Additionally, excessive toner can be supplied to the developing roller 5, causing poor developing density of the color. However, the helical coil 48 has a small transport pressure, and thus, when the pressure of the toner increases in the accommodating unit 41, the toner is not supplied to the accommodating unit 41 but returned to the toner supply unit 42 via the hollow center portion of the helical coil 48, even when the helical coil 48 rotates. Therefore, an excessive increase in the pressure of the toner in the accommodating unit 41 can be prevented.

As described above, developing cartridges and an electrophotographic color image forming apparatus having the same have the following effects.

First, the costs of consumables are decreased since toner cartridges can be replaced without replacing the developing cartridge.

Secondly, the developing cartridges and the electrophotographic color image forming apparatus can be minimized.

Thirdly, the electrophotographic color image forming apparatus may be minimized by arranging the toner supply units or the supply hole of the developing cartridges at different horizontal positions. Therefore, the electrophotographic color image forming apparatus is more convenient for users since the toner cartridges can be replaced without opening the electrophotographic color image forming apparatus.

Lastly, by installing a transport element in each of the toner supply units, toner supplied from the toner cartridge can be easily transported to the accommodating unit.

While the invention has been shown and described with reference to certain embodiments thereof, it will be understood by those skilled in the art that various changes in form and details may be made therein without departing from the spirit and scope of the invention as defined by the appended claims.

What is claimed is:

1. A developing cartridge which develops an electrostatic latent image on a photosensitive medium by receiving toner from a toner cartridge, the developing cartridge comprising:
an accommodating unit including a developing roller; and
a toner supply unit extending from a surface of the accommodating unit to connect the toner cartridge to the accommodating unit.

2. The developing cartridge of claim 1, wherein the toner supply unit comprises a transport element which transports the toner from the toner cartridge to the accommodating unit.

3. The developing cartridge of claim 1, wherein a width of the toner supply unit is narrower than a width of the accommodating unit.

4. The developing cartridge of claim 3, wherein the toner supply unit comprises a transport element which transports the toner from the toner cartridge to the accommodating unit.

5. The developing cartridge of claim 4, wherein the transport element is a rotatable helical coil.

6. The developing cartridge of claim 1, wherein the surface from which the toner supply unit extends is a rear surface of the accommodating unit.

7. An electrophotographic color image forming apparatus, comprising:
a photosensitive medium;
a plurality of toner cartridges; and
a plurality of developing cartridges which develop an electrostatic latent image on the photosensitive medium by receiving toner from the respective toner cartridges,
wherein each of the developing cartridges comprises:
an accommodating unit including a developing roller; and
a toner supply unit extending from a surface of the accommodating unit to connect the toner cartridge to the accommodating unit.

8. The electrophotographic color image forming apparatus of claim 7, wherein a portion of each of the toner cartridges is exposed to the outside of the electrophotographic color image forming apparatus.

9. The electrophotographic color image forming apparatus of claim 7, wherein each of the toner supply units comprises a transport element which transports the toner from the toner cartridge to the accommodating unit.

10. The electrophotographic color image forming apparatus of claim 8, wherein widths of the toner supply units are narrower than widths of the accommodating units.

11. The electrophotographic color image forming apparatus of claim 10, wherein the toner supply units of the developing cartridges are disposed at different locations along the length direction of the accommodating units.

12. The electrophotographic color image forming apparatus of claim 11, wherein each of the toner supply units comprises a transport element which transports the toner from the toner cartridge to the accommodating unit.

13. The electrophotographic color image forming apparatus of claim 12, wherein the transport elements are helical coils.

14. The electrophotographic image forming apparatus of claim 12, wherein a portion of each of the toner cartridges is exposed to the outside of the electrophotographic color image forming apparatus.

15. The developing cartridge of claim 7, wherein the surface from which the toner supply unit extends is a rear surface of the accommodating unit.

16. An electrophotographic color image forming apparatus, comprising:
a photosensitive medium;
a plurality of toner cartridges; and
a plurality of developing cartridges which develop an electrostatic latent image on the photosensitive medium by receiving toner from the respective toner cartridges,
wherein each of the developing cartridges comprises:
an accommodating unit including a developing roller; and
a toner supply hole formed in a cover of the accommodating unit via which the toner is supplied.

17. The electrophotographic color image forming apparatus of claim 16, wherein the toner supply holes of each developing cartridge are disposed at different locations along the length direction of the accommodating units.
